(19) United States
(12) Patent Application Publication
(10) Pub. No.: US 2020/0202864 A1
(43) Pub. Date: Jun. 25, 2020

(54) WIRELESS TRANSMITTING DEVICE AND CONTROL SYSTEM FOR ELECTRICAL APPARATUS

(71) Applicant: SHENZHEN LENKENG TECHNOLOGY CO., LTD., Shenzhen City (CN)

(72) Inventor: BINGHAI GAO, Shenzhen City (CN)

(21) Appl. No.: 16/442,449

(22) Filed: Jun. 14, 2019

(30) Foreign Application Priority Data
Dec. 20, 2018 (CN) 201822148635.2

(51) Int. Cl. G10L 17/00; G10L 25/84; G10L 21/0232; G10L 17/06

(52) U.S. Cl. CPC G10L 17/005; G10L 17/06; G10L 21/0232; G10L 25/84

(57) ABSTRACT

A wireless transmitting device converts a voice command into a wireless signal and transmits the wireless signal to the electrical apparatus to control the electrical apparatus. The wireless transmitting device includes a first collecting module collecting user's voice data, a voice recognition module, and a wireless transmitter. The voice recognition module extracts voice features from a target voice to acquire a voice feature of the target voice, and compares the voice feature of the target voice with a preset voice feature. The wireless transmitter sends the wireless signal to the electrical apparatus to control the electrical apparatus when the voice feature of the target voice matches the preset voice feature.

### CROSS REFERENCE TO RELATED APPLICATIONS

Pursuant to 35 U.S.C. § 119, this application claims foreign priority to Chinese Patent Application No. 201822148635.2 filed in Dec. 20, 2018, the contents of which, including any intervening amendments thereto, are incorporated herein by reference.

### TECHNICAL FIELD

The present disclosure relates to a wireless control technology, in particular to a wireless transmitting device and a control system for electrical apparatus.

### BACKGROUND

With the rise of intelligent life and smart homes, using voice commands to control smart home has become an emerging technology. Typically, in a voice command control system for electronic apparatus, voice recognition and conversion are key functions of the voice command control system. When the voice recognition and conversion function are performed, first, a voice command from a user is collected, second, the features of the collected voice commands are extracted, and third, the extracted voice features are recognized. Such that the content of the voice commands and identification of the user are recognized.

Since voice collection and voice conversion are the key functions of voice command control system, how to improve the accuracy of voice collection and voice conversion, realize long-distance propagation of controlled signals in wireless remote control device, and transmit the voice control command to ensure to correctly control the electronic apparatus are desired to solve in those skilled in the art.

### SUMMARY

In order to overcome the deficiencies of the prior art, the present disclosure provides a wireless transmitting device and a control system for electrical apparatus.

The objective of the present disclosure is achieved by the following technical solutions:

The wireless transmitting device converting a voice command into a wireless signal and transmitting the wireless signal to an electrical apparatus to control the electrical apparatus. The wireless transmitting device includes a first collecting module collecting user's voice data, a voice recognition module, and a wireless transmitter. The voice recognition module extracts voice features from a target voice to acquire a voice feature of the target voice, and compares the voice feature of the target voice with a preset voice feature. The wireless transmitter sends the wireless signal to the electrical apparatus to control the electrical apparatus when the voice feature of the target voice matches the preset voice feature.

Preferably, the wireless transmitting device further includes a transmitting module; the wireless transmitting device further includes a first body and a second body detachably coupled to the first body, the first collecting module is located in the first body, the voice recognition module is located in the second body, the first collecting module is communicated with the voice recognition module via the transmitting module.

Preferably, the transmitting module includes a transmitting line, the transmitting line is crimped in the first body or the second body, when the first body is detached from the second body, the transmitting line is expanded.

Preferably, the transmitting module includes a first communicating unit and a second communicating unit wirelessly communicated with the first communicating unit; the first communicating unit is located in the first body, the second communicating unit is located in the second body, the first communicating unit and the second communicating unit are wirelessly communicated and detachably couple together.

Preferably, the wireless transmitting device further includes a preprocessing module, the preprocessing module preprocesses the user's voice data collected by the first collecting module to acquire the target voice.

Preferably, the wireless transmitting device further includes a storage module storing preset voice commands including the preset voice feature.

Preferably, the wireless transmitting device further includes a body, the first collecting module, the preprocessing module, and the wireless transmitter are located in the body.

Preferably, the wireless transmitting device further includes a preprocessing module, the preprocessing module preprocesses the user's voice data collected by the first collecting module to acquire target voice.

Preferably, the wireless transmitting device further includes a storage module storing preset voice commands including the preset voice feature.

Preferably, the wireless transmitter includes a wireless generating unit, a signal modulation unit, and a wireless transmitting unit; the signal modulation unit is electrically connected to the wireless generating unit to modulate the wireless signal to a modulated wireless signal, and the wireless transmitting unit is electrically connected to the signal modulation unit to send the modulated wireless signal to the electrical apparatus.

Preferably, a frequency of the modulated wireless signal is 433 MHz, 902-928 MHz, 2.4 GHz or 5.8 GHz.

Preferably, the preprocessing module includes an interference suppression unit electrically connected to the first collecting module and a noise filtering unit; the interference suppression unit processes the user's voice data collected by the first collecting module to acquire a voice data with a high signal-to-noise ratio; the noise filtering unit is connected to the interference suppression unit, and processes the voice data with the high signal-to-noise ratio to acquire the target voice.

Preferably, the wireless transmitter further includes a control unit connected to the voice recognition module, the wireless transmitter receives and analyzes a first feedback signal sent by the voice recognition module to generate the wireless signal.

Preferably, the wireless transmitting device further includes a self-setting voice collecting module connected to the storage module and a voice binding module; the self-setting voice collecting module collects user's self-setting voice commands, and extracts and sends a self-setting voice feature of the user's self-setting voice command to the storage module; the voice binding module binds the self-setting voice feature with the preset voice feature.

Preferably, the voice binding module includes a voice binding unit and a binding prompt unit, and the voice binding unit is connected to the binding prompt unit; the voice binding unit binds the self-setting voice feature with the preset voice feature to control the binding prompt unit to send a prompt message.

Preferably, the wireless transmitting device further includes a second collecting module connected to the preprocessing module; the second collecting module acquires an ambient noise, and analyzes and feeds back a noise level of the ambient noise to the preprocessing module.

Preferably, the preprocessing module further includes an adjustment unit connected to the second collecting module and the interference suppression unit, and the adjustment unit adjusts an interference suppression strength of the interference suppression unit according to the noise level of the ambient noise from the second collecting module.

A control system for an electrical apparatus includes an electrical apparatus and a wireless transmitting device converting a voice command into a wireless signal and transmitting the wireless signal to the electrical apparatus for controlling the electrical apparatus. The wireless transmitting device includes a first collecting module collecting user's voice data, a voice recognition module, and a wireless transmitter; the voice recognition module extracts voice features from a target voice to acquire a voice feature of the target voice, and compares the voice feature of the target voice with a preset voice feature; the wireless transmitter sends the wireless signal to the electrical apparatus to control the electrical apparatus when the voice feature of the target voice matches the preset voice feature.

Compared with the prior art, the wireless transmitting device of the disclosure has the following advantages:

Firstly, the user's preset voice command is stored locally by the storage module, and the preset voice command data can be used quickly without using the cloud to store the voice command. The first collecting module is configured to receive the user's voice data, the interference suppression unit of the preprocessing module is configured to suppress the interference signal in the voice data from the first collecting module to improve the signal-to-noise ratio of the voice data from the first collecting module, and the noise filtering unit is configured to further eliminate the interference signal to effectively preserve the user's voice in the voice data, that is, the target voice. The voice recognition module is configured to extract the voice feature of the target voice from the preprocessing module, and compare the voice feature of the target voice with the preset voice feature stored in the storage module. If the ratio the voice feature of the target voice to the preset voice feature is greater than or equal to the speech feature matching threshold, the voice recognition module sends the first feedback signal to the wireless transmitter, and the wireless transmitter sends the wireless signal to control the electrical apparatus.

Further, the wireless control signal may be loaded to the higher carrier frequency by modulating, and the size of the antenna can be greatly reduced. The plurality of wireless control signals may be loaded to different carrier frequencies to achieve channel multiplexing and improve channel utilization. In addition, the modulation may extend the signal bandwidth, improve the system's anti-interference and anti-fading ability, and increase the signal-to-noise ratio during transmission.

Secondly, the user may effectively extend the preset voice command through the self-setting voice collection module and the voice binding module. Thus, the plurality of voice commands can be used to control the same action of the electrical apparatus, thereby effectively avoiding the user's inability to control the electrical apparatus because of forgetting the voice command.

Thirdly, the second collecting module is configured to acquire the ambient noise, analyze the noise level of the ambient noise, and send the second feedback signal of the noise level to the preprocessing module, and thus the preprocessing module may adjust the filtering strength of the noise according to the different noise levels to acquire the relative good target voice, which increases the sound recognition effect.

### BRIEF DESCRIPTION OF THE DRAWINGS

FIG. 1 is a block diagram of a wireless transmitting device according to a first embodiment.

FIG. 2A is a block diagram of a first collecting module of the wireless transmitting device according to the embodiment.

FIG. 2B is a block diagram of another first collecting module of the wireless transmitting device according to the embodiment.

FIG. 3 is a block diagram of a preprocessing module of the wireless transmitting device according to the embodiment.

FIG. 4 is a block diagram of a voice recognition module of the wireless transmitting device according to the embodiment.

FIG. 5 is a block diagram of a wireless transmitter of the wireless transmitting device according to the embodiment.

FIG. 6A is a block diagram of a wireless transmitting device according to a second embodiment.

FIG. 6B is a block diagram of a voice binding module of the wireless transmitting device according to the second embodiment.

FIG. 7 is a block diagram of a wireless transmitting device according to a third embodiment.

FIG. 8 is a block diagram of a wireless transmitting device according to a fourth embodiment.

Symbols: 10, 20, 30, 40, wireless transmitting device; 11, 21, 31, 41, first collecting module; 111, voice collecting unit; 112, second transmission unit; 113, first transmission unit; 114, power supply unit; 115, switching unit; 13, 23, 33, 43, preprocessing module; 131, 331, 431, interference suppression unit; 132, 332, 432, noise filtering unit; 14, 24, 34, 44, voice recognition module; 141, threshold setting unit; 142, feature extracting unit; 143, matching analysis unit; 15, 25, 35, 45, wireless transmitter; 151, 251, control unit; 153, 253, wireless generating unit; 155, 255, signal modulation unit; 157, 257, wireless transmitting unit; 16, 26, 36, 46, storage module; 27, voice binding module; 271, voice binding unit; 272, binding prompt unit; 28, self-setting voice collection module; 32, 42, second collecting module; 321, 421, level preset unit; 322, 422, noise collecting unit; 323, 423, noise analysis unit; 333, 433, adjustment unit; 435, signal compensation unit.

### DETAILED DESCRIPTION OF THE PREFERRED EMBODIMENTS

Several embodiments of the present disclosure will be described in greater detail with reference to the drawings. It should be noted that the figures are illustrative rather than limiting. The figures are not drawn to scale, do not illustrate every aspect of the described embodiments, and do not limit the scope of the present disclosure.

### Embodiment 1

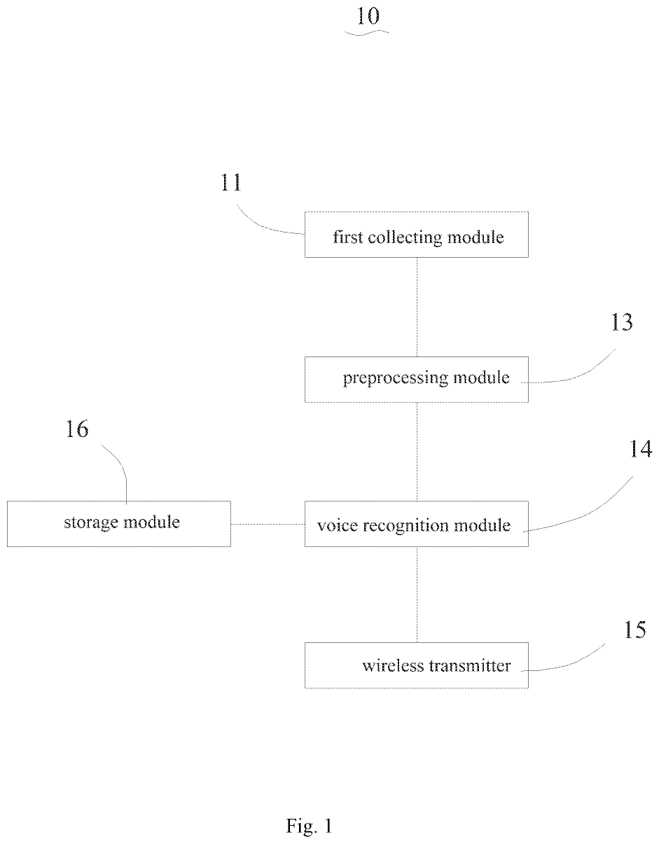

Referring to FIG. 1, a wireless transmitting device 10 in accordance with a first embodiment includes a first collecting module 11, a preprocessing module 13, a voice recognition module 14, a wireless transmitter 15, and a storage module 16. The storage module 16 is configured to store one or more preset voice commands including one or more preset voice features. The first collecting module 11 is configured to collect user's voice data, and the preprocessing module 13 is configured to preprocess the user's voice data collected by the first collecting module 11 to eliminate interferential voice to acquire target voice. The voice recognition module 14 is connected to the preprocessing module 13, the storage module 16, and the wireless transmitter 15. The voice recognition module 14 is configured to extract voice feature from the target voice, compare the voice feature of the target voice with the preset voice features to acquire a comparison result, and send a first feedback signal to the wireless transmitter 15 according to the comparison result. The wireless transmitter 15 generates a wireless signal according to the first feedback signal, and modulates the wireless signal. Thus, the voice command may be used to control electrical apparatus having a wireless sensor, such as a refrigerator, an air conditioner, a fan, a television, etc. In a far range, the range is set according to a receiving range of the wireless sensor of the electrical apparatus and a transmitting range of the wireless signal sent by the wireless transmitter 15.

The connection relationship in this embodiment refers to a point connection relationship and/or a signal connection relationship between two elements, which enable the signals to be transmitted between the two elements.

In several embodiments, the wireless transmitting device 10 includes a body, the first collecting module 11, the preprocessing module 13, the voice recognition module 14, the wireless transmitter 15, and the storage module 16 are located in the body. In several embodiments, the wireless transmitting device 10 includes a two body, such as a first body and a second body. The first collecting module 11 is located in the first body; the preprocessing module 13, the voice recognition module 14, the wireless transmitter 15, and the storage module 16 are located in the second body. In the following descriptions, it takes the wireless transmitting device 10 with the first body and the second body as an example.

In several embodiments, the wireless transmitting device 10 further includes a transmitting module. The first collecting module 11 is located in the first body, the voice recognition module 14 is located in the second body, and the first collecting module 11 is communicated with the voice recognition module 14 via the transmitting module. The transmitting module includes a transmitting line, the transmitting line is crimped in the first body or the second body, when the first body is detached from the second body, the transmitting line is expanded.

In several embodiments, the transmitting module includes a first communicating unit and a second communicating unit wirelessly communicated with the first communicating unit; the first communicating unit is located in the first body, the second communicating unit is located in the second body, the first communicating unit and the second communicating unit are wirelessly communicated and detachably couple together.

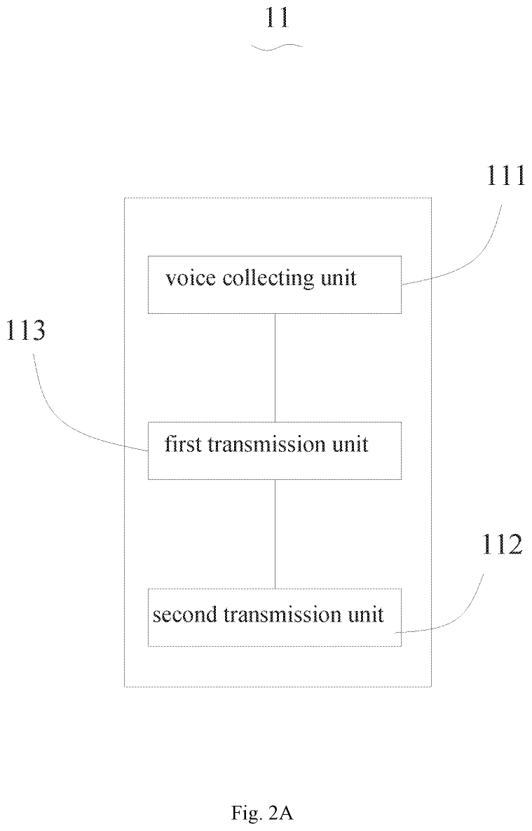

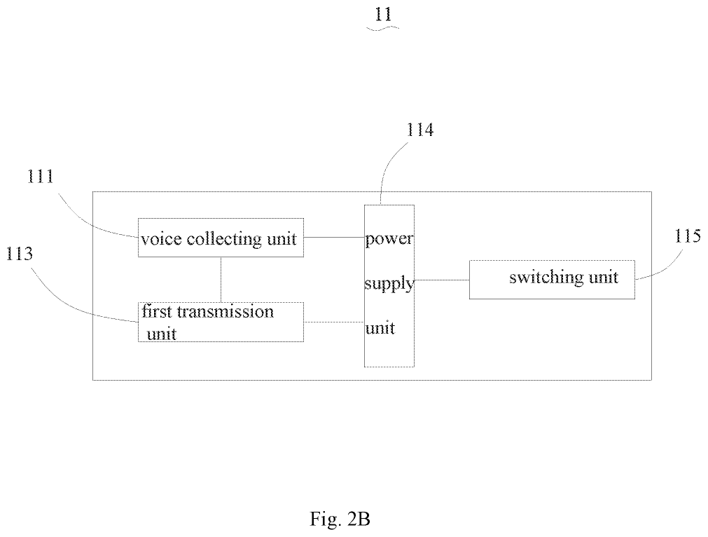

Referring to FIG. 2A, the first collecting module 11 includes a voice collecting unit 111 and a first transmission unit 113. The voice collecting unit 111 is configured to acquire the user's voice data. The voice collecting unit 111 may be but not limited to a single microphone or a microphone matrix, and the first transmission unit 113 may be but not limited to a Universal Serial Bus (USB) interface, a General Purpose Interface Bus (GPIB) interface, or an Electronic Industry Association Recommended Standard 232 (EIA-RS-232) interface.

The first transmission unit 113 is connected to the voice collecting unit 111 and is configured to transmit the user's voice data from the voice collecting unit 111 to the preprocessing module 13, and the preprocessing module 13 preprocesses the voice data and eliminates the interferential voice to acquire the target voice.

In several embodiments, the first collecting module 11 further includes a second transmission unit 112 electrically connected to the first transmission unit 113 and detachably connected to the preprocessing module 13. Therefore, the first collecting module 11 may be detachably connected to the preprocessing module 13 in socket joint mode through the second transmission unit 112, in order to easily replace the first collecting module 11 after being damaged. The first transmission unit 113 and the second transmission unit 112 are considered as a pair of matching interfaces of a transmission module.

In addition, the first collecting module 11 is detachably coupled to the preprocessing module 13 to wire communicate with the preprocessing module 13 through the second transmission unit 112, which ensures that the first collecting module 11 is stably communicated with the preprocessing module 13, and the preprocessing module 13 is better to process the signal transmission between the first collecting module 11 and the preprocessing module 13.

In this embodiment, the first transmission unit 113 and the preprocessing module 13 are communicated with each other using wire or not based on 3G network, 4G network, or Wi-Fi, and it is not limited herein.

Referring to FIG. 2B, in several embodiments, the first collecting module 11 further includes a power supply unit 114 and a switching unit 115. The power supply unit 114 is connected to and supplies power for the voice collecting unit 111 and the first transmission unit 113. The switching unit 115 is connected to the power supply unit 114, and is configured to turn on and off the power supply unit 114. The switching unit 115 may be a mechanical switch such as a button or a paddle, or an inductive switch such as a touch control or a voice control.

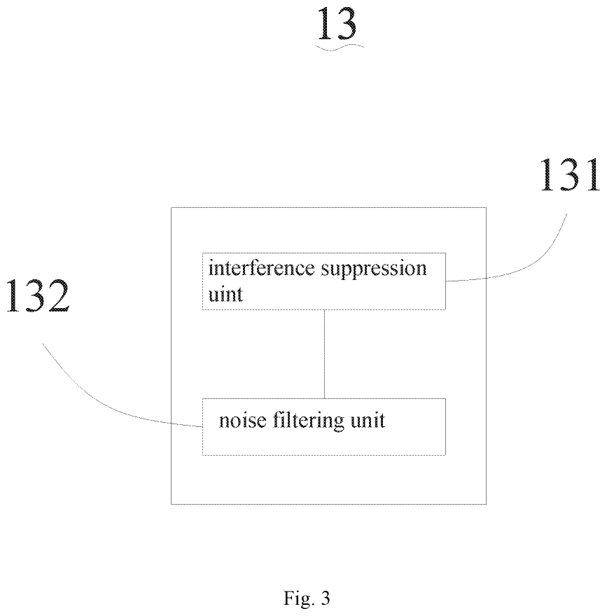

Referring to FIG. 3, the preprocessing module 13 includes an interference suppression unit 131 electrically connected to the first collecting module 11 and a noise filtering unit 132. The interference suppression unit 131 is configured to suppress the interference voice of the voice data collected by the first collecting module 11 during the voice data being transmitting. In detail, the interference suppression unit 131 is configured to improve a signal-to-noise ratio of the voice data collected by the first collecting module 11 to acquire the voice data with a high signal-to-noise ratio. The interference suppression unit 131 is a chip having a suppression function of disrobed above. Thus, the noise filtering unit 132 may filter well the voice data to acquire the target voice. The noise filtering unit 132 is connected to the interference suppression unit 131 and is configured to filter an ambient noise and/or delete a blank voice to the voice data processed by the interference suppression unit 131 to acquire pure human voice data, the voice data processed by the interference suppression unit 131 is also the voice data with the high signal-to-noise ratio, and the pure human voice data is the target voice which is also called target voice data or target signal. The noise filtering unit 132 may be but not limited to a chip having a filtering function of disrobed above.

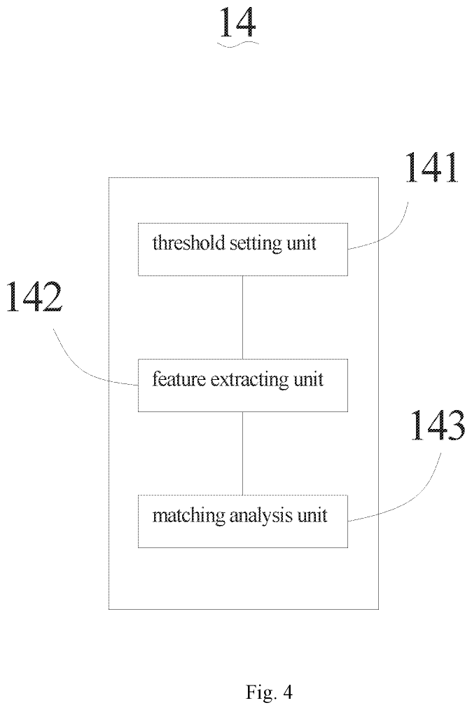

Referring to FIG. 4, the voice recognition module 14 includes a threshold setting unit 141, a feature extracting unit 142, and a matching analysis unit 143. The feature extracting unit 142 is configured to extract voice feature of the target voice from the preprocessing module 13, and the voice feature of the target voice may include one feature, two features or three features from features of sound intensity, loudness, pitch, and pitch period and so on. The sound intensity refers to an average sound energy per unit area passing through a direction that is perpendicular to a sound wave propagation direction in per unit time, the loudness of the sound refers to a degree of sound intensity that we subjectively feel, the pitch refers to a feeling of human auditory system for sound frequency, and the pitch period refers to the time from turning on a vocal cord to turning off the vocal cord once. For example, a voice recognition used by the voice recognition module 14 may be a voice recognition based on a convolutional neural network algorithm and/or a voice recognition based on a voiceprint feature extraction. The voice recognition module 14 may be but not limited to a chip having a recognition function of disrobed above, and the feature extracting unit 142 may be but not limited to a chip having a function of extracting above-mentioned voice features.

The threshold setting unit 141 is configured to set a speech feature matching threshold. The threshold setting unit 141 receives a setting command input by an input device and sets the speech feature matching threshold, and the input device may be but not limited to some physical buttons, virtual soft buttons, and so on.

The matching analysis unit 143 is configured to compare the voice feature of the target voice acquired from the feature extracting unit 142 with the preset voice feature stored in the storage module 16, and send the first feedback signal to the wireless transmitter 15 according to the comparison result. The wireless transmitter 15 receives and analyzes the first feedback signal to generate and send the wireless signal to control the electrical apparatus. The matching analysis unit 143 may be a comparator or a comparing circuit.

Specifically, if a ratio of the voice feature of the target voice acquired from the feature extracting unit 142 to the preset voice feature stored in the storage module 16 is greater than or equal to the speech feature matching threshold set in the threshold setting unit 141, the matching analysis unit 143 sends a positive first feedback signal to the wireless transmitter 15. The positive first feedback signal includes specific information of the wireless signal to be transmitted, that is, a code corresponding to the wireless signal. Thus, different wireless signals may be sent through different voice commands to control different electrical apparatuses or control the same apparatus to achieve various functions. The wireless transmitter 15 receives and analyzes the first feedback signal to generate and send the wireless signal to control the electrical apparatus. If the ratio of the voice feature of the target voice acquired from the feature extracting unit 142 to the preset voice feature stored in the storage module 16 is smaller than the speech feature matching threshold set in the threshold setting unit 141, the matching analysis unit 143 sends a negative first feedback signal to the wireless transmitter 15 or doesn't send the first feedback signal to the wireless transmitter 15. Thus, the wireless transmitter 15 doesn't send the wireless signal.

For example, it is assumed that the preset voice feature stored in the storage module 16 is an instruction statement “Please turn on the fan” from user A, and the first collecting module 11 collects voice data of instruction statement “Turn on the fan” or “Please turn on the fan” from the user A or user B. The preprocessing module 13 preprocesses the voice data of the instruction statements from the user A or the user B to eliminate interferential voice to acquire the target voice data of the instruction statement, the feature extracting unit 142 of the voice recognition module 14 extracts the voice feature from the target voice data to acquire the voice feature of the target voice, and the matching analysis unit 143 compares the voice feature of the target voice of the instruction statement “Turn on the fan” or “Please turn on the fan” from the user A or the user B acquired from the feature extracting unit 142 with the preset voice feature of the command statement “Please open the fan” from the user A. If the ratio is greater than or equal to the speech feature matching threshold set in the threshold setting unit 141, matching is successful, the matching analysis unit 143 sends the positive first feedback signal to the wireless transmitter 15, and the wireless transmitter 15 receives and analyzes the first feedback signal to generate and send the wireless signal to control the electrical apparatus. For example, the threshold is 90%, a ratio of the voice feature of the target voice of the instruction statement “Turn on the fan” or “Please turn on the fan” from the user A or user B acquired by the feature extracting unit 142 to the preset voice feature of the instruction statement “Please turn on the fan” from user A stored in the storage module 16 is greater than or equal to 90%, the matching is successful, the matching analysis unit 143 sends the positive first feedback signal to the wireless transmitter 15, and the wireless transmitter 15 receives and analyzes the first feedback signal to generate and send the wireless signal to control the electrical apparatus. Conversely, the matching analysis unit 143 sends the negative first feedback signal to the wireless transmitter 15 or does not send the first feedback signal to the wireless transmitter 15, the wireless transmitter 15 doesn't send the wireless signal.

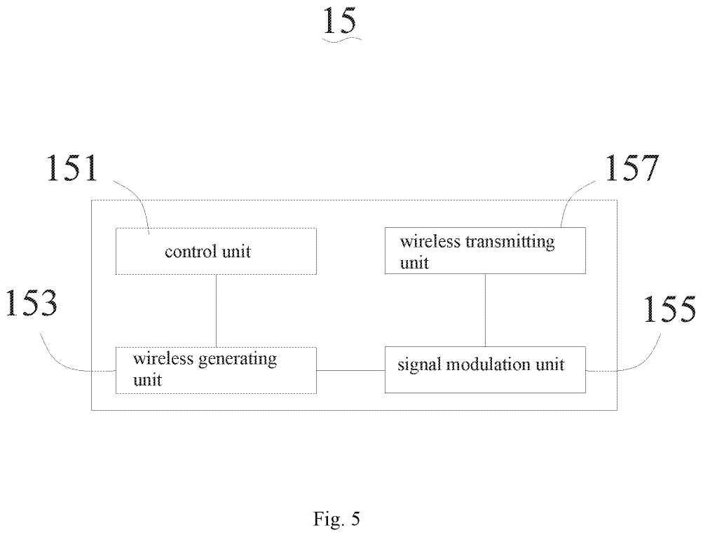

Referring to FIG. 5, the wireless transmitter 15 includes a control unit 151, a wireless generating unit 153, a signal modulation unit 155, and a wireless transmitting unit 157. The control unit 151 is connected to the wireless generating unit 153 and the matching analysis unit 143 of the voice recognition module 14, and is configured to receive and analyze the first feedback signal sent by the matching analysis unit 143 to control the wireless generating unit 153 to generate the wireless signal according to the first feedback signal. The signal modulation unit 155 is electrically connected to the wireless generating unit 153 to modulate the wireless signal generated by the wireless generating unit 153 to a modulated wireless signal. The wireless transmitting unit 157 is electrically connected to the signal modulation unit 155 to send the modulated wireless signal to the electrical apparatus having the wireless sensor, thus controlling the electrical apparatus.

The signal, which can be modulated, may be a digital signal or an analog signal. The modulation based on the digital signal may be amplitude shift keying (ASK), frequency-shift keying (FSK), phase shift keying (PSK), or quadrature amplitude modulation (QAM). The wireless control signal is radiated into the space through the antenna in the form of electromagnetic waves, in order to acquire a relative high radiation efficiency, the size of the antenna is generally greater than a quarter of the wavelength of the transmitted signal. The lower frequency component of the converted wireless control signal has a longer wavelength, which makes the antenna too long to be realized. Therefore, the wireless control signal may be loaded to a higher carrier frequency by modulating, and the size of the antenna can be greatly reduced. A plurality of wireless control signals may be loaded to different carrier frequencies to achieve channel multiplexing and improve channel utilization. In addition, the modulation may extend the signal bandwidth, improve the system's anti-interference and anti-fading ability, and increase the signal-to-noise ratio during transmission.

In this embodiment, the wireless signal may be an infrared signal, a Wi-Fi signal, a Bluetooth signal, a wireless signal of Industrial Scientific Medical (ISM) band, or a wireless signal in an unlicensed and publicly used frequency band that is specified by the International Telecommunication Union.

Preferably, the modulated wireless signal modulated by the signal modulation unit 155 is the wireless signal of ISM band with a frequency of 433 MHz, 902-928 MHz, 2.4 GHz or 5.8 GHz.

Specifically, it is assumed that the positive first feedback signal is a binary code such as “0101”, “0100”. The binary code “0101” is mapped with a type A wireless signal controlling the fan to swing, and the binary code “0100” is mapped with a type B wireless signal controlling to turn on the fan.

When the signal from the matching analysis unit 143 is the positive first feedback signal, the control unit 151 analyzes the positive first feedback signal to acquire the binary code “0100”, and controls the wireless generating unit 153 to correspondingly yield the type B wireless signal. The type B wireless signal modulated by the signal modulation unit 155 has high energy and long propagation distance, and the wireless transmitting unit 157 transmits the type B wireless signal to the electrical apparatus and controls the electrical apparatus to be on.

When the signal from the matching analysis unit 143 is the negative first feedback signal, or the control unit 151 doesn't receive the signal from the matching analysis unit 143, the wireless generation unit 153 does not operate.

In this embodiment, the preset voice command pre-stored in the storage module 16 may be one or more voice commands of one user, or may be a plurality of voice commands of many users. The plurality of voice commands may control the electrical apparatus to perform the same action, which is achieved through converting the plurality of voice commands into the same wireless signal having the same feature by the wireless transmitter 15, and the wireless signal feature may be the wavelength and/or frequency of the wireless signal. The different voice commands may also be used to control the electrical apparatus to perform different actions, which is achieved through converting the different voice commands into the wireless signal having corresponding feature by the wireless transmitter 15.

The speech feature matching threshold of the threshold setting unit 141 can be set according to user's preference. The speech feature matching threshold may be in a range of greater than 0 and less than 1. Particularly, assume the speech feature matching threshold value is α, 1>α≥65%, more particularly, 1>α≥90%.

In the disclosure, the user's preset voice command is stored locally by the storage module 16, and the preset voice command data can be used quickly without using the cloud to store the voice command. The first collecting module 11 is configured to receive the user's voice data, the interference suppression unit 131 of the preprocessing module 13 is configured to suppress the interference signal in the voice data from the first collecting module 11 to improve the signal-to-noise ratio of the voice data from the first collecting module 11, and the noise filtering unit 132 is configured to further eliminate the interference signal to effectively preserve the user's voice in the voice data, that is, the target voice. The voice recognition module 14 is configured to extract the voice feature of the target voice from the preprocessing module 13, and compare the voice feature of the target voice with the preset voice feature stored in the storage module 16. If the ratio the voice feature of the target voice to the preset voice feature is greater than or equal to the speech feature matching threshold, the voice recognition module 14 sends the first feedback signal to the wireless transmitter 15, the wireless transmitter 15 generates and modulates the wireless signal to have long propagation distance, and sends the modulated wireless signal to the electrical apparatus. The electrical apparatus is configured to receive and demodulate the modulated wireless signal, and operate according to the user's voice command, that is, the electrical apparatus is remotely controlled by using the voice command.

### Embodiment 2

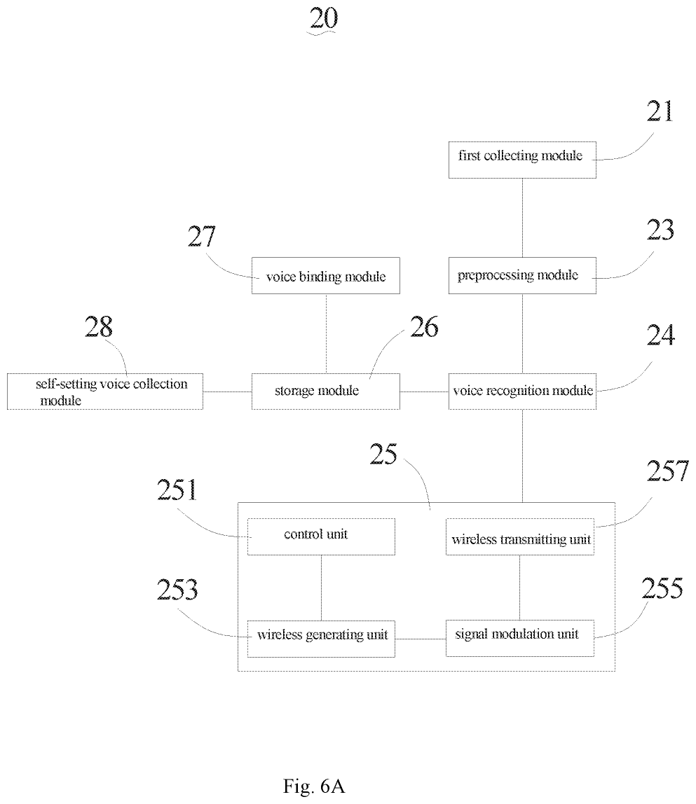

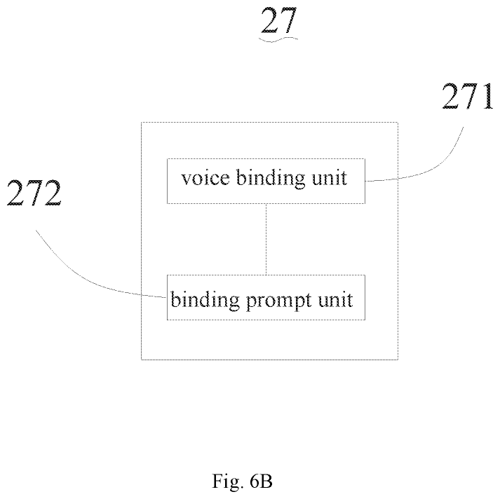

Referring to FIGS. 6A-6B, a wireless transmitting device 20 in accordance with a second embodiment includes a first collecting module 21, a preprocessing module 23, a voice recognition module 24, a storage module 26, and a wireless transmitter 25.

The first collecting module 21, the preprocessing module 23, the voice recognition module 24, the wireless transmitter 25, and the storage module 26 in the second embodiment and the first collecting module 11, the preprocessing module 13, the voice recognition module 14, the wireless transmitter 15, and the storage module 16 in the first embodiment have the same connection relationship and functions, and are not described herein.

The second embodiment is different from the first embodiment in that the wireless transmitting device 20 further includes a self-setting voice collecting module 28 and a voice binding module 27. The self-setting voice collecting module 28 is connected to the storage module 26 and is configured to collect a user's self-setting voice command, extract and send a self-setting voice feature of the user's self-setting voice command to the storage module 26. The voice binding module 27 is configured to bind the self-setting voice feature with the preset voice feature, thus, the user can control the electrical apparatus through the self-setting voice.

Specifically, the voice binding module 27 includes a voice binding unit 271 and a binding prompt unit 272. The voice binding unit 271 is connected to the binding prompt unit 272, and is configured to bind the self-setting voice feature with the preset voice feature and send a binding feedback signal to the binding prompt unit 272 after the binding is successful. The binding prompt unit 272 receives the binding feedback signal, and sends a prompt message to the user to indicate that the binding is successful. The prompt message may be a flash, a text, or a voice. Preferably, the prompt message is the voice. The voice binding unit 271 may be but not limited to a Microcontroller Unit (MCU).

A method of collecting the self-setting voice feature used by the self-setting voice collection module 28 can refer to the method of collecting and processing the voice command used by the first collecting module 21 and the preprocessing module 23, and it will not be described again.

For example, the preset voice command “Turn on the fan” corresponds to turning on the fan. When the user wants to turn on the fan with the self-setting voice command “OPEN”, the self-setting voice feature of the self-setting voice command “OPEN” is collected by the self-setting voice collection module 28, the voice binding unit 271 binds or associates the self-setting voice feature of the self-setting voice command “OPEN” with the preset voice feature of the preset voice command “Turn on the fan”, and the binding prompt unit 272 sends a voice “Congratulation, the binding is successful” after the binding is successful. Therefore, the user can turn on the fan through the voice command “OPEN”.

In the embodiment, the user effectively extends the preset voice command through the self-setting voice collection module 28 and the voice binding module 27. Thus, the plurality of voice commands can be used to control the same action of the electrical apparatus, thereby effectively avoiding the user's inability to control the electrical apparatus because of forgetting the voice command.

### Embodiment 3

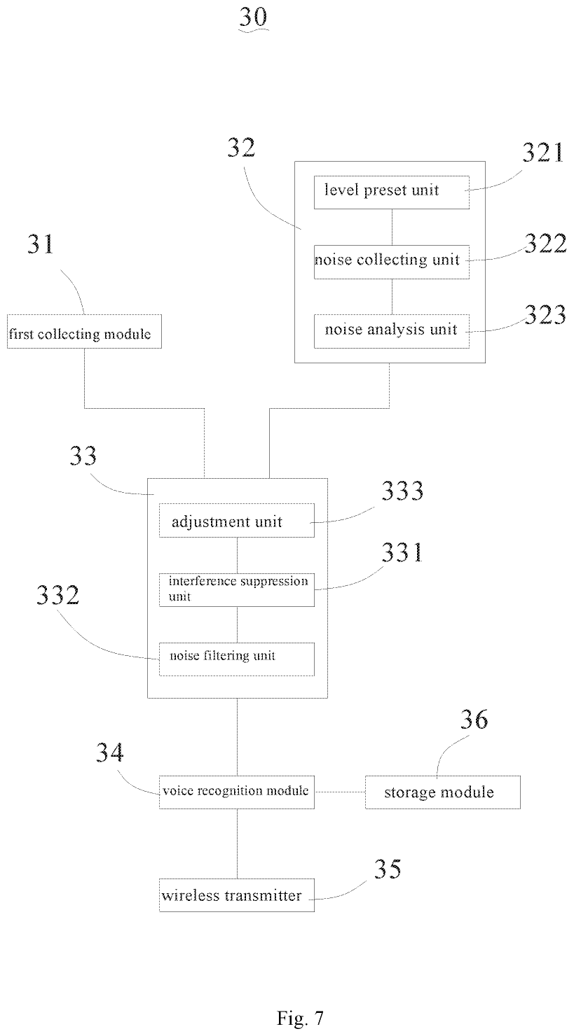

Referring to FIG. 7, a wireless transmitting device 30 in accordance with a third embodiment includes a first collecting module 31, a second collecting module 32, a preprocessing module 33, a voice recognition module 34, and a storage module 36, and a wireless transmitter 35.

The first collecting module 31, the voice recognition module 34, the storage module 36, and the wireless transmitter 35 in the third embodiment and the first collecting module 11, the voice recognition module 14, the storage module 16, and the wireless transmitter 15 in the first embodiment have the same connection relationship and functions, and are not described herein.

The second collecting module 32 is connected to the preprocessing module 33, and is configured to acquire an ambient noise and analyze a noise level of the ambient noise, and feedback the noise level of the ambient noise to the preprocessing module 33, the preprocessing module 33 adjusts a noise filtering intensity according to the noise level of the ambient noise.

Specifically, the second collecting module 32 includes a level preset unit 321, a noise collecting unit 322, and a noise analysis unit 323. The level preset unit 321 is configured to preset the noise level, and the noise collecting unit 322 is configured to collect the ambient noise where the wireless transmitting device 30 is located. The noise analysis unit 323 is connected to the level preset unit 321 and the noise collecting unit 322, and is configured to compare the ambient noise collected by the noise collecting unit 322 with the preset noise level of the level preset unit 321, determine the level of the noise collected by the noise collecting unit 322, and send a second feedback signal of the noise level to the preprocessing module 33, and the preprocessing module 33 adjusts the noise filtering intensity according to the noise level.

The preprocessing module 33 includes an adjustment unit 333, an interference suppression unit 331, and a noise filtering unit 332. The interference suppression unit 331 and/or the noise filtering unit 332 are provided with a plurality of intensity levels, and the adjustment unit 333 is connected to the noise analysis unit 323, the interference suppression unit 331, and the noise filtering unit 332. The adjustment unit 333 is configured to adjust interference suppression strength of the interference suppression unit 331 and/or filtering strength of the noise filtering unit 332 according to the noise level determined by the noise analysis unit 323 to acquire a relative good target voice, which increases the sound recognition effect.

For example, setting the sound of 20-40 decibels to be the first-level noise, setting the sound of 40-60 decibels to be the second-level noise, setting the sound of 60-90 decibels to the third-level noise, and setting the sound of more than 90 decibels to fourth-level noise. When the ambient noise collected by the noise collecting unit 322 is between 40 and 60 decibels, the noise analysis unit 323 determines that the ambient noise is the second-level noise, and generates and sends a second-level-noise second feedback signal to the adjustment unit 333, and thus the adjustment unit 333 may adjust the interference suppression strength of the interference suppression unit 331 and/or the filtering strength of the noise filtering unit 332 according to the second feedback signal.

It can be understood that, in the embodiment, the first collecting module 31, the voice recognition module 34, the storage module 36, and the wireless transmitter 35 in the third embodiment and the first collecting module 21, the voice recognition module 24, the storage module 26, and the wireless transmitter 25 in the second embodiment have the same connection relationship and functions, and are not described herein.

In the embodiment, the second collecting module 32 is configured to acquire the ambient noise, analyze the noise level of the ambient noise, and send the second feedback signal of the noise level to the preprocessing module 33, and thus the preprocessing module 33 may adjust the filtering strength of the noise according to the different noise levels to acquire the relative good target voice, which increases the sound recognition effect.

As an alternative to the third embodiment, the wireless transmitting device 30 may further include the self-setting voice collection module and the voice binding module, connection relationship and functions of which are same as that of the voice collection module 28 and the voice binding module 27 in the second embodiment, and are not described herein.

### Embodiment 4

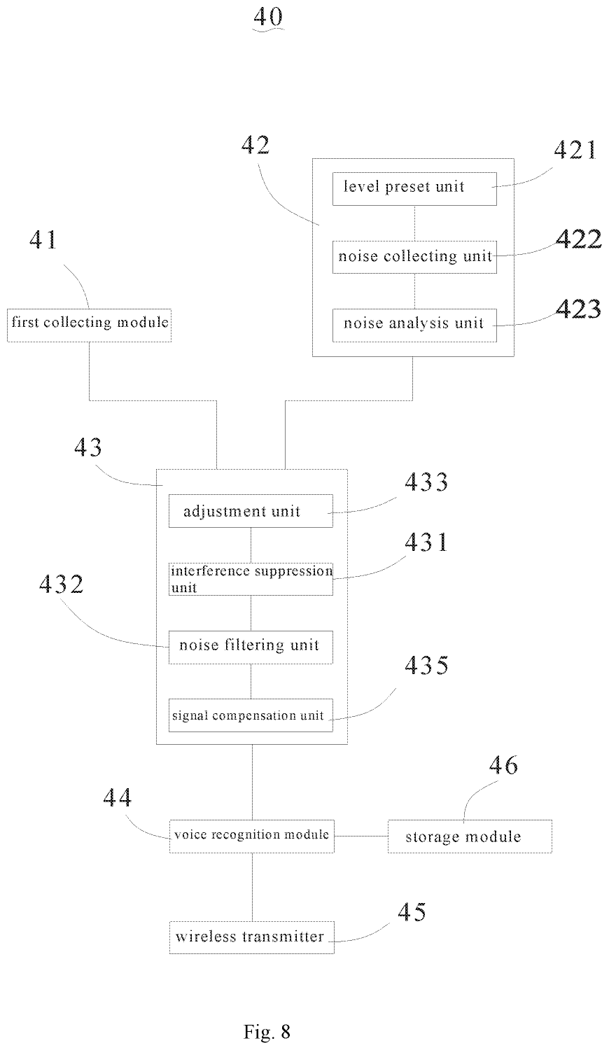

Referring to FIG. 8, a wireless transmitting device 40 in accordance with a fourth embodiment includes a first collecting module 41, a second collecting module 42, a preprocessing module 43, a voice recognition module 44, a storage module 46, and a wireless transmitter 45.

The first collecting module 41, the second collecting module 42, the voice recognition module 44, the storage module 46, and the wireless transmitter 45 in the embodiment and the first collecting module 31, the second collecting module 32, the voice recognition module 34, the storage module 36, and the wireless transmitter 35 in the third embodiment have the same connection relationship and function, and are not described herein.

The fourth embodiment is different from the third embodiment in that the preprocessing module 43 includes an adjustment unit 433, an interference suppression unit 431, a noise filtering unit 432, and a signal compensation unit 435. The adjustment unit 433, the interference suppression unit 431, and the noise filtering unit 432 in the embodiment have the same connection relationship and function as the adjustment unit 333, the interference suppression unit 331 and the noise filtering unit 332 corresponding to the third embodiment, and are not described herein.

The signal compensation unit 435 is connected to the noise filtering unit 432, and is configured to compensate data loss of the voice command when the interference suppression unit 431 and the noise filtering unit 432 process the noise. The compensation amount may be a fixed value or be set according to the noise level of the collected ambient noise, thus improving the conversion capacity on the voice command.

### Embodiment 5

A control system for an electrical apparatus in accordance with a fifth embodiment includes an electrical apparatus and a wireless transmitting device. The wireless transmitting device and anyone of the wireless transmitting device 10 provided by the first embodiment, the wireless transmitting device 20 provided by the second embodiment, the wireless transmitting device 30 provided by the third embodiment, and the wireless transmitting device 40 provided by the fourth embodiment have the same connection relationship and function, and are not described herein. In the electrical apparatus control system, the wireless transmitting device converts the user's voice command into the corresponding wireless signal, and the electrical apparatus receives, analyzes, and recognizes the wireless signal, thus remotely controlling the electrical apparatus.

Compared with the prior art, the wireless transmitting device of the disclosure has the following advantages:

Firstly, the user's preset voice command is stored locally by the storage module, and the preset voice command data can be used quickly without using the cloud to store the voice command. The first collecting module is configured to receive the user's voice data, the interference suppression unit of the preprocessing module is configured to suppress the interference signal in the voice data from the first collecting module to improve the signal-to-noise ratio of the voice data from the first collecting module, and the noise filtering unit is configured to further eliminate the interference signal to effectively preserve the user's voice in the voice data, that is, the target voice. The voice recognition module is configured to extract the voice feature of the target voice from the preprocessing module, and compare the voice feature of the target voice with the preset voice feature stored in the storage module. If the ratio the voice feature of the target voice to the preset voice feature is greater than or equal to the speech feature matching threshold, the voice recognition module sends the first feedback signal to the wireless transmitter, and the wireless transmitter sends the wireless signal to control the electrical apparatus.

Further, the wireless control signal may be loaded to the higher carrier frequency by modulating, and the size of the antenna can be greatly reduced. The plurality of wireless control signals may be loaded to different carrier frequencies to achieve channel multiplexing and improve channel utilization. In addition, the modulation may extend the signal bandwidth, improve the system's anti-interference and anti-fading ability, and increase the signal-to-noise ratio during transmission.

Secondly, the user may effectively extend the preset voice command through the self-setting voice collection module and the voice binding module. Thus, the plurality of voice commands can be used to control the same action of the electrical apparatus, thereby effectively avoiding the user's inability to control the electrical apparatus because of forgetting the voice command.

Thirdly, the second collecting module is configured to acquire the ambient noise, analyze the noise level of the ambient noise, and send the second feedback signal of the noise level to the preprocessing module, and thus the preprocessing module may adjust the filtering strength of the noise according to the different noise levels to acquire the relative good target voice, which increases the sound recognition effect.

The above embodiments are only the preferred embodiments of the present invention, and do not limit the scope of the present invention. A person skilled in the art may make various other corresponding changes and deformations based on the described technical solutions and concepts. And all such changes and deformations shall also fall within the scope of the present invention.

What is claimed is:

1. A wireless transmitting device, converting a voice command into a wireless signal and transmitting the wireless signal to an electrical apparatus to control the electrical apparatus, the wireless transmitting device comprises:
a first collecting module collecting user's voice data;
a voice recognition module, extracting voice features from a target voice to acquire a voice feature of the target voice, and comparing the voice feature of the target voice with a preset voice feature; and
a wireless transmitter sending the wireless signal to the electrical apparatus to control the electrical apparatus when the voice feature of the target voice matches the preset voice feature.

2. The wireless transmitting device of claim 1, wherein the wireless transmitting device further comprises a transmitting module; the wireless transmitting device further comprises a first body and a second body detachably coupled to the first body, the first collecting module is located in the first body, the voice recognition module is located in the second body, the first collecting module is communicated with the voice recognition module via the transmitting module.

3. The wireless transmitting device of claim 2, wherein the transmitting module comprises a transmitting line, the transmitting line is crimped in the first body or the second body, when the first body is detached from the second body, the transmitting line is expanded.

4. The wireless transmitting device of claim 2, wherein the transmitting module comprises a first communicating unit and a second communicating unit wirelessly communicated with the first communicating unit; the first communicating unit is located in the first body, the second communicating unit is located in the second body, the first communicating unit and the second communicating unit are wirelessly communicated and detachably couple together.

5. The wireless transmitting device of claim 2, wherein the wireless transmitting device further comprises a preprocessing module, the preprocessing module preprocesses the user's voice data collected by the first collecting module to acquire the target voice.

6. The wireless transmitting device of claim 3, wherein the wireless transmitting device further comprises a storage module storing preset voice commands comprising the preset voice feature.

7. The wireless transmitting device of claim 1, wherein the wireless transmitting device further comprises a body, the first collecting module, the voice recognition module, and the wireless transmitter are located in the body.

8. The wireless transmitting device of claim 7, wherein the wireless transmitting device further comprises a preprocessing module, the preprocessing module preprocesses the user's voice data collected by the first collecting module to acquire target voice.

9. The wireless transmitting device of claim 8, wherein the wireless transmitting device further comprises a storage module, the storage module stores preset voice commands comprising the preset voice feature.

10. The wireless transmitting device of claim 6, wherein the wireless transmitter comprises a wireless generating unit, a signal modulation unit, and a wireless transmitting unit; the signal modulation unit is electrically connected to the wireless generating unit to modulate the wireless signal to a modulated wireless signal, and the wireless transmitting unit is electrically connected to the signal modulation unit to send the modulated wireless signal to the electrical apparatus.

11. The wireless transmitting device of claim 10, wherein a frequency of the modulated wireless signal is 433 MHz, 902-928 MHz, 2.4 GHz or 5.8 GHz.

12. The wireless transmitting device of claim 10, wherein the preprocessing module comprises an interference suppression unit electrically connected to the first collecting module and a noise filtering unit; the interference suppression unit processes the user's voice data collected by the first collecting module to acquire a voice data with a high signal-to-noise ratio; the noise filtering unit is connected to the interference suppression unit, and processes the voice data with the high signal-to-noise ratio to acquire the target voice.

13. The wireless transmitting device of claim 10, wherein the wireless transmitter further comprises a control unit connected to the voice recognition module, the wireless transmitter receives and analyzes a first feedback signal sent by the voice recognition module to generate the wireless signal.

14. The wireless transmitting device of claim 10, wherein the wireless transmitting device further comprises a self-setting voice collecting module connected to the storage module and a voice binding module; the self-setting voice collecting module collects user's self-setting voice commands, and extracts and sends a self-setting voice feature of the user's self-setting voice command to the storage module; the voice binding module binds the self-setting voice feature with the preset voice feature.

15. The wireless transmitting device of claim 14, wherein the voice binding module comprises a voice binding unit and a binding prompt unit, and the voice binding unit is connected to the binding prompt unit; the voice binding unit binds the self-setting voice feature with the preset voice feature to control the binding prompt unit to send a prompt message.

16. The wireless transmitting device of claim 10, wherein the wireless transmitting device further comprises a second collecting module connected to the preprocessing module; the second collecting module acquires an ambient noise, and analyzes and feeds back a noise level of the ambient noise to the preprocessing module.

17. The wireless transmitting device of claim 16, wherein the preprocessing module further comprises an adjustment unit connected to the second collecting module and the interference suppression unit, and the adjustment unit adjusts an interference suppression strength of the interference suppression unit according to the noise level of the ambient noise from the second collecting module.

18. A control system for an electrical apparatus, comprising:
an electrical apparatus; and
a wireless transmitting device converting a voice command into a wireless signal and transmitting the wireless signal to the electrical apparatus to control the electrical apparatus;
wherein the wireless transmitting device comprises a first collecting module collecting user's voice data, a voice recognition module, and a wireless transmitter; the voice recognition module extracts voice features from a target voice to acquire a voice feature of the target voice, and compares the voice feature of the target voice with a preset voice feature; the wireless transmitter sends the wireless signal to the electrical apparatus to control the electrical apparatus when the voice feature of the target voice matches the preset voice feature.

19. The control system for the electrical apparatus of claim 18, wherein the wireless transmitting device further comprises a transmitting module; the wireless transmitting device further comprises a first body and a second body detachably coupled to the first body, the first collecting module is located in the first body, the voice recognition module is located in the second body, the first collecting module is communicated with the voice recognition module via the transmitting module.

20. The control system for the electrical apparatus of claim 18, wherein the wireless transmitting device further comprises a body, the first collecting module, the voice recognition module, and the wireless transmitter are located in the body.
